(19) United States
(12) Patent Application Publication
(10) Pub. No.: US 2003/0140012 A1
(43) Pub. Date: Jul. 24, 2003

(54) Method for estimating the effect of characteristics on product preference

(75) Inventors: William Eugene Harvey, Appleton, WI (US); Peggy Jo Kintner, Appleton, WI (US); Allen Anthony Warmus, Menasha, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/020,637

(22) Filed: Dec. 14, 2001

(51) Int. Cl. G06F 17/60

(52) U.S. Cl. 705/400; 705/10

(57) ABSTRACT

A method for determining preference results from test subjects attributable to an attribute of a product, the method including calculating a base preference for the product, where the base preference is the ratio of the number of test subjects who preferred the product overall but not with respect to the attribute to the number of test subjects who did not prefer the product with respect to the attribute. The method also includes calculating a downside for the product by taking the difference between the base preference and the overall preference, where the overall preference is the ratio of the number of test subjects who preferred the product overall to the total number of test subjects. The method also includes calculating an upside for the product by taking the difference between the overall preference and the best preference, where the best preference is the ratio of the number of test subjects who preferred the product both overall and with respect to the attribute to the number of test subjects who preferred the product with respect to the attribute.

### BACKGROUND

The present invention relates generally to product preference testing. More particularly, the present invention relates to a method for accounting for preferences related to an attribute of a product.

Marketing researchers and their clients have traditionally searched for analytical techniques to assist in evaluating causality in consumer testing of products. For example, in a paired-comparison use test, clients first question which product was preferred overall, followed closely by questioning why that product was preferred overall. In other words, clients want to understand which characteristic or characteristics caused the overall preference. This latter question is usually addressed by a perusal of open-ended “reasons for preference” and/or some subjective or analytic evaluation of preference on key attributes or problems experienced during use.

One analytic approach used frequently is Matching Coefficients, an appealing technique because of its face validity, ease of understanding, and simplicity of calculation. Matching Coefficients attempts to estimate the importance of attributes by summing the proportion of respondents who preferred a product on an attribute and preferred the same product overall with those who had no preference on an attribute and had no overall preference. Another analytic approach is Attributable Effects, an alternative that, like Matching Coefficients, attempts to estimate the importance of attributes. The Attributable Effects method is described at www.marketfacts.com/publications/#A.

### SUMMARY

The Matching Coefficients method, attractive as it is, also has some limitations. It provides no information about the degree of preference that would be expected to be gained by improving performance on an attribute, nor on the potential loss of preference that might be caused by degrading attribute performance. Further, Matching Coefficients ignores differences between products within a given paired-comparison test, treating them in unison.

Likewise, the analytical approach of Attributable Effects has deficiencies that limit its usefulness including, for example, how “no preference” choices are treated. In addition, previous explanations of Attributable Effects have not been very straightforward, and many researchers have had reservations with the logic, calculation, and application of the technique. Moreover, there have been at least two different methods used for calculating Attributable Effects, depending upon which supplier provided the analysis. These methods differ in their treatment or non-treatment of “no preference” votes.

The invention described herein incorporates an analytical technique for estimating the potential gain and downside involved in manipulating the attribute delivery of a product or the promised delivery of that attribute. The invention described herein is an analytic approach, called Upside/Downside Analysis, that has advantages over the other alternatives. The method of calculation is relatively straightforward and can be comprehensively explained. In addition, the approach provides information separately for each product in a test, and uses the totality of information collected for its estimates. Finally, the downside of decreasing the level of delivery of a product characteristic is quantified in addition to the benefit to be gained by increasing said delivery.

This disclosure is not claiming invention of the idea of preference analyses. The novel concept described herein is the method of handling “no preference” responses that are often obtained during consumer testing. Prior analyses by other practitioners have either ignored “no preference” votes, or attempted to change them to “preference” votes by following some complex manipulation scheme. The approach in this disclosure treats “no preference” responses as legitimate non-choices, and includes their impact in the analysis.

This invention describes a method for determining preference results from test subjects attributable to an attribute of a product, the method including calculating a base preference for the product, where the base preference is the ratio of the number of test subjects who preferred the product overall but not with respect to the attribute to the number of test subjects who did not prefer the product with respect to the attribute. The method also includes calculating a downside for the product by taking the difference between the base preference and the overall preference, where the overall preference is the ratio of the number of test subjects who preferred the product overall to the total number of test subjects. The method also includes calculating an upside for the product by taking the difference between the overall preference and the best preference, where the best preference is the ratio of the number of test subjects who preferred the product both overall and with respect to the attribute to the number of test subjects who preferred the product with respect to the attribute.

Additionally, the invention provides a test results interpretation system including a matrix of responses including preference results by input choices, and a computer code resident on a computer adapted to calculate product preference for a product by incorporating preference results and nonpreferential results. The computer code can be adapted to calculate a base preference for the product, wherein the base preference is the overall preference where no test subject prefers the product on its delivery of the attribute. The base preference is the ratio of the number of test subjects who preferred the product overall but not with respect to the attribute to the number of test subjects who did not prefer the product with respect to the attribute. The computer code can also be adapted to calculate a downside for the product, wherein the downside is the incremental overall preference above the base preference attributable to the attribute. The computer code can also be adapted to calculate an upside for the product, wherein the upside is the incremental overall preference attributable to the maximum potential attribute preference.

Other objects and advantages of the present invention will become more apparent to those skilled in the art in view of the following description and the accompanying drawings.

### DRAWINGS

The foregoing and other features, aspects, and advantages of the present invention will become better understood with regard to the following description, appended claims, and accompanying drawing where:

FIG. 1 is a tabular illustration of four components of overall product preference, according to the present invention.

FIG. 2 is a plot comparing preference components for a given attribute of a product.

FIG. 3 is a tabular illustration of an example analysis according to the present invention.

### DETAILED DESCRIPTION OF THE PREFERRED EMBODIMENTS

The methodology described herein uses a paired-comparison test as an example. The methodology can likewise be used to calculate measures for monadic use tests or for tests providing other types of data, such as concept interest tests. Extension of the methodology to these other situations is not described in detail, but would follow logic similar to that described herein. Similarly, the methodology described herein can be used regardless of the type of product, and has universal applicability. As used herein, the terms attribute and characteristic are synonymous and interchangeable.

As a generic example, a test of product preference yields paired-comparison data on overall preference and on an attribute. In essence, a Test Product is compared to a Control Product, wherein both products each include some level of Attribute X. Test subjects select which product they prefer on an overall basis, and which product they prefer with respect to its delivery of Attribute X. The data can be arrayed in a 3×3 table:

| | PRODUCT PREFERRED ON ATTRIBUTE X | | | |
|---|---|---|---|---|
| | Test Product | Control Product | Neither | Total |
| PRODUCT | | | | |
| PREFERRED | | | | |
| OVERALL | | | | |
| Test | A | B | C | K |
| Product | | | | |
| Control | D | E | F | L |
| Product | | | | |
| Neither | G | H | J | M |
| Total | N | P | Q | R |

where:

A=the number of people who prefer the Test Product both overall and with respect to Attribute X.

B=the number of people who prefer the Test Product overall, but the Control Product on Attribute X.

C=the number of people who prefer the Test Product overall, but neither product on Attribute X.

D=the number of people who prefer the Control Product overall, but the Test Product on Attribute X.

E=the number of people who prefer the Control Product both overall and with respect to Attribute X.

F=the number of people who prefer the Control Product overall, but neither product on Attribute X.

G=the number of people who prefer neither product overall, but the Test Product on Attribute X.

H=the number of people who prefer neither product overall, but the Control Product on Attribute X.

J=the number of people who prefer neither product overall, and neither product on Attribute X.

K=A+B+C=the total number of people who prefer the Test Product overall, regardless of Attribute X.

L=D+E+F=the total number of people who prefer the Control Product overall, regardless of Attribute X.

M=G+H+J=the total number of people who prefer neither product overall, regardless of Attribute X.

N=A+D+G=the total number of people who prefer the Test Product for Attribute X, regardless of which product they prefer overall.

P=B+E+H=the total number of people who prefer the Control Product for Attribute X, regardless of which product they prefer overall.

Q=C+F+J=the total number of people who prefer neither product for Attribute X, regardless of which product they prefer overall.

R=A+B+C+D+E+F+G+H+J=the total number of test subjects.

An “Attained Overall Preference” for each product can be calculated based on the total number of test subjects who prefer a product overall, compared to the total number of test subjects. This number is taken regardless of the test subjects' preference on Attribute X:

| | | No overall |
|---|---|---|
| For the Test Product: | For the Control Product: | preference |
| Attained Overall Preference = | Attained Overall Preference = | M/R = |
| K/R = OP % | L/R = OP % | NP % |

where OP=the Attained Overall Preference percentage for a given product, and NP=“No Preference,” which is the percentage of test subjects who prefer neither product overall. In a given test, the percentage of test subjects who prefer either product, or neither product, is commonly determined. Typically, the No Preference selections are disposed of as irrelevant to the preferences of the two products, or are apportioned between the two products by some complex manipulation of the numbers.

A test subject who prefers neither product overall, however, is making a legitimate choice of not preferring either product. In prior art methods, that legitimate choice is typically marginalized by disposal or false apportionment, when the non-preference could be used by the tester as a source of useful information. By analogy, undecided voters in an election campaign are not ignored; they are in fact often studied to determine what issues (or attributes) might allow them to make a decision. Undecided voters are often seen as fertile ground for gaining votes. The process described herein seeks to determine what potential for added preference may be available in the No Preference test subjects.

Product preference may be based on a single attribute of the product, or on a number of attributes of a product. The process described herein uses a single attribute for exemplary purposes, but the process would typically be extended to multiple attributes. Overall preference for one product or another can be thought of as being made up of four components with regard to a given attribute:

1) There is likely some level of “Base Preference,” or the overall preference that a product would receive regardless of the delivery of that attribute. 2) There is some level of overall preference dependent upon delivery of that attribute. This component is labeled “Downside,” because if the product no longer delivers this attribute, the downside may be losing preference back to the base level. 3) There is some level of “Upside” overall preference that could be achieved if delivery of the attribute is improved. 4) Finally, there is some level of overall preference that is unattainable no matter how much the product is improved on a given attribute. This level is labeled “Not Reachable.”

These factors, along with the preferences resulting from their combination, are summarized in FIG. 1. Base Preference plus Downside equals the “Attained Overall Performance” already achieved by the product with a given attribute. Base Preference plus Downside plus Upside equals the “Best Preference,” the maximum preference attainable by the product with a given attribute. Finally, Base Preference plus Downside plus Upside plus Not Reachable equals the “Total Possible Preference,” which is 100 percent and accounts for all of the preference factors.

This composition of overall preference for each product, with respect to a given attribute, can be diagrammed as illustrated in FIG. 1.

Again, using the paired-comparison use test as an example, the analysis uses data for overall preference and attribute preference to provide estimates for the four components. The generic 3×3-table example used above will be supplied with hypothetical numerical values to illustrate the analysis methodology:

| | PRODUCT PREFERRED ON ATTRIBUTE X | | | |
|---|---|---|---|---|
| | Test Product | Control Product | Neither | Total |
| PRODUCT | | | | |
| PREFERRED | | | | |
| OVERALL | | | | |
| Test | 35 | 11 | 8 | 54 |
| Product | | | | |
| Control | 13 | 52 | 6 | 71 |
| Product | | | | |
| Neither | 7 | 3 | 9 | 19 |
| Total | 55 | 66 | 23 | 144 |

Attained Overall Preference, as described above, is calculated as follows:

| | | No |
|---|---|---|
| | | Overall |
| For the Test Product: | For the Control Product: | Preference |
| Attained Overall Preference = | Attained Overall Preference = | 19/144 = |
| 54/144 = 38% | 71/144 = 49% | 13% |

For the first or Base Preference component, the analysis determines the level of overall preference that a product would receive regardless of the delivery of a given attribute. The Base Preference component is determined by answering this question: If no one had preferred the Test Product on Attribute X, what Attained Overall Preference would the Test Product have achieved?

In the example, 66 people preferred the Control Product with respect to Attribute X (and regardless of their overall choice), while 23 people had no preference on the attribute. Of these 66+23 or 89 people, 11+8 or 19 of them still preferred the Test Product overall, although they did not prefer the Test Product with respect to Attribute X (i.e., those 19 people are listed under the Control Product or No Preference with respect to Attribute X). So if no one preferred the Test Product on Attribute X, which is the case for those 89 people, there would still be 19 of those 89 or 21% that would still prefer the Test Product overall even though they did not prefer the Test Product with respect to Attribute X. This 21% is the Base Preference of the Test Product, or the overall preference the Test Product should receive even if the Test Product is not preferred on Attribute X. In other words, 21% should prefer the Test Product whether or not it delivers Attribute X. It should be noted that this analysis does not require that everyone prefer the Control Product—only that they do not prefer the Test Product. Some prefer the Control Product and some have No Preference. Again, No Preference is a legitimate non-choice and is treated as such, thus avoiding confounding theoretical problems encountered by some other practitioners resulting from ignoring No Preference votes or from apportioning them to the competing products. The Base Preference for the Control Product may be calculated in a like manner. To reiterate:

| For the Test Product: | For the Control Product: |
|---|---|
| Base Preference = | Base Preference = (13 + 6)/(55 + 23) = 24% |
| (11 + 8)/(66 + 23) = 21% | |

For the second or Downside component, the analysis determines the level of overall preference of a product attributable to delivery of a given attribute. This component is labeled Downside, because if the product no longer delivers this attribute, the downside may be losing preference back to the Base Preference level.

The benefit derived from the current performance level of the Test Product with respect to Attribute X, and what the Test Product risks losing if it loses that level of performance on this attribute, is represented by the difference between the Attained Overall Preference actually achieved by the Test Product (38%) and the Base Preference (21%). In other words, the Downside is the portion of the Attained Overall Preference that is attributable to Attribute X, over and above the Base Preference. Again, the Downside for the Control Product may be calculated in a like manner. To reiterate:

| For the Test Product: | For the Control Product: |
|---|---|
| Attained Overall Preference = 38% | Attained Overall Preference = 49% |
| Base Preference = 21% | Base Preference = 24% |
| Downside = 38% − 21% = 17% | Downside = 49% − 24% = 25% |

For the third or Upside component, the analysis determines the level of overall preference for a product that could be achieved if delivery of a given attribute is improved. One first calculates the Best Preference, that is, the overall preference that should be attained if everyone prefers the product on the attribute. The Best preference component is determined by answering this question: If everyone preferred the Test Product on Attribute X, what overall preference would the Test Product have achieved? The estimate to this question provides a way of dimensioning the potential gain to overall preference to be achieved from maximizing the delivery of any given attribute.

In the example, among those 55 people who preferred the Test Product on the attribute, 35 (or 64%) also preferred the Test Product overall. As a result, the estimate of the best overall preference the Test Product could hope to achieve by “winning” everyone on this particular attribute is 64%. The Upside gain is the difference between the Attained Overall Preference actually received by the Test Product (38%) and this best possible outcome (64%). Again, the Upside for the Control Product may be calculated in a like manner. To reiterate:

| For the Test Product: | For the Control Product: |
|---|---|
| Best Preference = 35/55 = 64% | Best Preference = 52/66 = 79% |
| Upside = Best Preference minus | Upside = Best Preference minus |
| Attained Overall Preference = | Attained Overall Preference = |
| 64% − 38% = 26% | 79% − 49% = 30% |

Finally, for the fourth or Not Reachable component, the analysis determines the level of overall preference that is unattainable no matter how much a product is improved on a given attribute. The Not Reachable component is simply determined by calculating the difference between the best possible preference and the total population.

In the example, the best possible preference (64%) is subtracted from the total population (100%) to determine the Not Reachable population. Again, the Not Reachable for the Control Product may be calculated in a like manner. To reiterate:

| For the Test Product: | For the Control Product: |
|---|---|
| Not Reachable = 100% minus Best | Not Reachable = 100% minus Best |
| Preference = 100% − 64% = 36% | Preference = 100% − 79% = 21% |

To summarize the results of the calculations of the four components for both the Test and Control Products with respect to Attribute X:

| | Test Product | Control Product |
|---|---|---|
| Base Preference | 21% | 24% |
| Downside | 17% | 25% |
| Upside | 26% | 30% |
| Not Reachable | 36% | 21% |
| Total | 100% | 100% |

In the example, the Control Product has both a higher Base Preference, and a higher Upside than the Test Product with respect to Attribute X, indicating that Control Product is probably a better candidate for development, at least with respect to Attribute X.

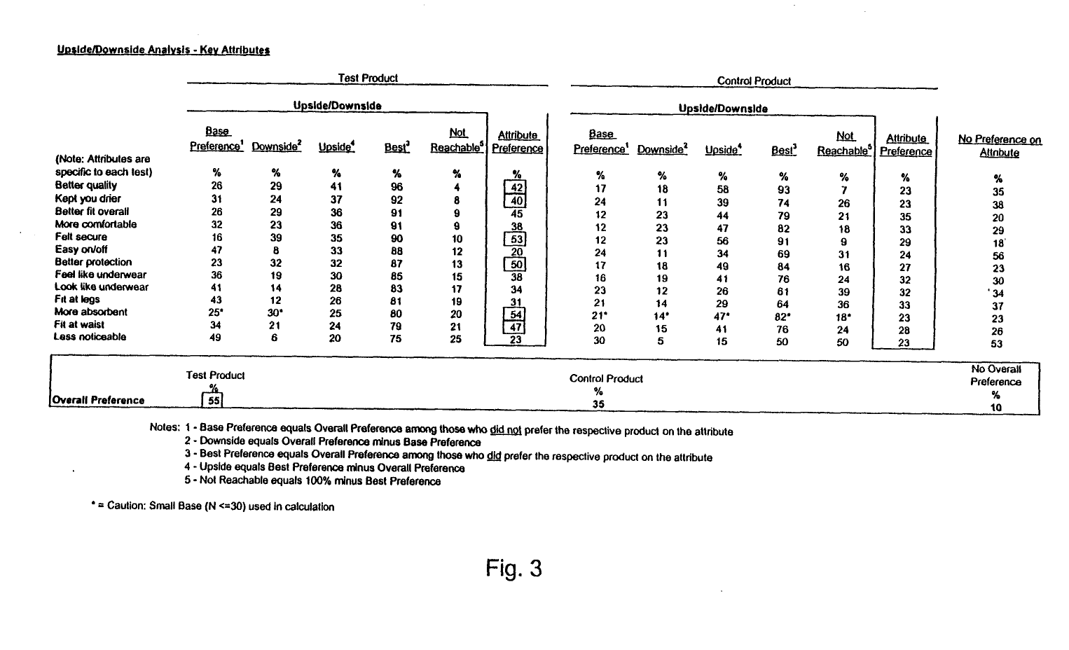

In a specific example, as illustrated in FIG. 3, analysis results are shown for a test of adult incontinence protective underwear. The test incorporates a Test Product and a Control Product that are tested with respect to thirteen attributes, including attributes of fit, quality, and protection. Each attribute is analyzed using the methodology described herein.

In an actual analysis, the tester would perform these calculations for all attributes in the study, and then rank them for those attributes that provide the greatest risk or Downside, and again for those that provide the greatest potential gain or Upside. This information would tell the tester which attributes they need to be careful to maintain (or risk losing), and on which attributes they might want to concentrate their efforts to improve (for potential gain). A useful way to present data such as these is to develop a plot in which the Downside values are assigned to the horizontal (X) axis, while the Upside values are assigned to the vertical (Y) axis.

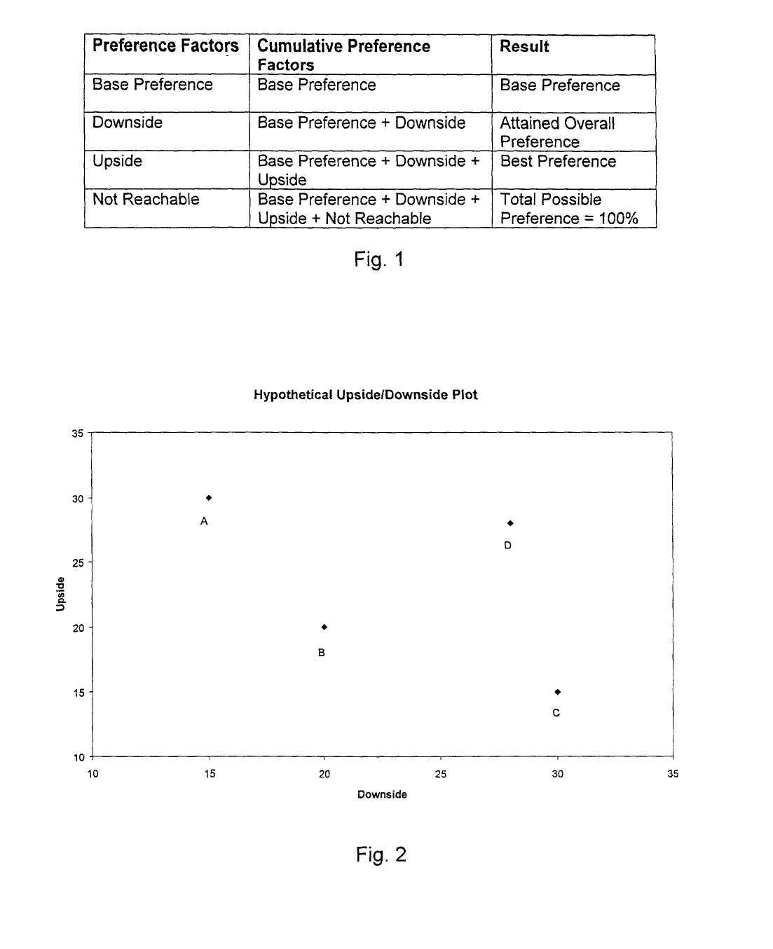

As an example, four hypothetical attributes, each with an associated combination of Downside and Upside calculated by the methodology described herein, are identified as A-D and plotted in FIG. 2.

In this hypothetical example, it is apparent that Attribute A has high Upside but relatively low Downside. Attribute C has high Downside but low Upside. Attribute D has both high Downside and high Upside. Therefore, based on the calculations underlying this hypothetical plot, either Attribute A or D appear to have the greatest potential for gain if developed in a manner that will maximize their delivery. In addition, one would want to be careful to not decrease the delivery of Attributes D or C because of their potential Downside.

The method described herein can be used to compare consumer preferences for any products and their attributes. The method is particularly useful for analyzing preferences for products in which attributes may be subtly different, or in which the attributes represent subtle changes over those of previous products. For example, the method may be used to analyze product preference for consumer products, for personal care products, for health care products, for disposable products, for absorbent products, or for any combination thereof.

If, in addition to these two diagnostic measures (Downside and Upside), one also desires a single summary measure to rank attributes in priority, one might choose the “Best Preference” statistic described earlier. Again, Best Preference is simply the percent of respondents preferring a product overall among those who preferred that same product on a given attribute. This is an estimate of the highest preference that may be achieved with respect to an attribute if the delivery of that attribute is maximized.

It is important to note that these calculations or those for any other measure do not absolve the analyst from using judgment and common sense in analyzing the data. For example, if the number of people who prefer either product on an attribute is small, then the Upside/Downside measures calculated for this attribute could exhibit volatility. Also, because it is possible to realize negative values for both Downside and Upside with this methodology, the judgement of the analyst should be used to determine if, as implied by such a result, delivery of this attribute will have more of a negative impact than a positive impact for a given product.

In an alternate embodiment, the Upside/Downside analysis could also be applied to “Problems Experienced During Use,” another measure often obtained during the conduct of a paired-comparison use test, although this application typically involves small sample sizes. One could calculate the Upside/Downside measures for Problems in the same way as they were done for Attributes, or one could use an alternative method such as calculating the increase in preference that should occur if those who had a problem with our product were to no longer experience that problem, and they then preferred our product in the same proportion as those who didn't have a problem in the first place. In practice, however, problems are often stated in such a way that they are the converse of the presence of an attribute, so the problems analysis likely would be complimentary. Moreover, it is noted that reported problems during use above some threshold of noise of perhaps 10% or so should be addressed regardless of calculations, particularly if the tester has a disadvantage in a given area.

As various changes could be made in the foregoing methodology without departing from the scope of the invention, it is intended that all matter contained in the above description shall be interpreted as illustrative and not in a limiting sense. Accordingly, this invention is intended to embrace all such alternatives, modifications, and variations that fall within the spirit and scope of the appended claims.

We claim:

1. A method for determining preference results for a product having an attribute, the method comprising:
calculating a base preference for the product;
calculating a downside for the product; and
calculating an upside for the product.

2. The method of claim 1, wherein the base preference is the overall preference for the product where no test subject prefers the product on its delivery of the attribute.

3. The method of claim 1, wherein the base preference is the ratio of the number of test subjects who preferred the product overall but not with respect to the attribute to the number of test subjects who did not prefer the product with respect to the attribute.

4. The method of claim 1, wherein the downside is the incremental overall preference above the base preference attributable to the attribute.

5. The method of claim 1, wherein calculating the downside for the product includes taking the difference between a base preference and an overall preference, wherein the overall preference is the ratio of the number of test subjects who preferred the product overall to the total number of test subjects.

6. The method of claim 1, wherein the upside is the incremental overall preference attributable to the maximum potential attribute preference.

7. The method of claim 1, wherein calculating an upside for the product includes taking the difference between the overall preference and the best preference, where the best preference is the ratio of the number of test subjects who preferred the product both overall and with respect to the attribute to the number of test subjects who preferred the product with respect to the attribute.

8. A method for developing a product having first and second attributes, the method comprising:
calculating a base preference, a downside, and an upside for the first attribute;
calculating a base preference, a downside, and an upside for the second attribute;
comparing the calculations to determine which attribute is superior; and
developing the product with the superior attribute.

9. The method of claim 8, wherein the base preference is the overall preference for the product where no test subject prefers the product on its delivery of an attribute.

10. The method of claim 8, wherein the base preference is the ratio of the number of test subjects who preferred the product overall but not with respect to the attribute to the number of test subjects who did not prefer the product with respect to the attribute.

11. The method of claim 8, wherein the downside is the incremental overall preference above the base preference attributable to the attribute.

12. The method of claim 8, wherein calculating the downside for the product includes taking the difference between a base preference and an overall preference, wherein the overall preference is the ratio of the number of test subjects who preferred the product overall to the total number of test subjects.

13. The method of claim 8, wherein the upside is the incremental overall preference attributable to the maximum potential attribute preference.

14. The method of claim 8, wherein calculating an upside for the product includes taking the difference between the overall preference and the best preference, where the best preference is the ratio of the number of test subjects who preferred the product both overall and with respect to the attribute to the number of test subjects who preferred the product with respect to the attribute.

15. A method for determining preference results for a product having an attribute, the method comprising:
calculating a base preference for the product, wherein the base preference is the overall preference where no test subject prefers the product on its delivery of the attribute;
calculating a downside for the product, wherein the downside is the incremental overall preference above the base preference attributable to the attribute; and
calculating an upside for the product, wherein the upside is the incremental overall preference attributable to the maximum potential attribute preference.

16. The method of claim 15, wherein the base preference is the ratio of the number of test subjects who preferred the product overall but not with respect to the attribute to the number of test subjects who did not prefer the product with respect to the attribute.

17. The method of claim 15, wherein calculating the downside for the product includes taking the difference between the base preference and the overall preference, where the overall preference is the ratio of the number of test subjects who preferred the product overall to the total number of test subjects.

18. The method of claim 15, wherein calculating an upside for the product includes taking the difference between the overall preference and the best preference, where the best preference is the ratio of the number of test subjects who preferred the product both overall and with respect to the attribute to the number of test subjects who preferred the product with respect to the attribute.

19. A method for determining preference results from test subjects attributable to an attribute of a product, the method comprising:
calculating a base preference for the product, where the base preference is the ratio of the number of test subjects who preferred the product overall but not with respect to the attribute to the number of test subjects who did not prefer the product with respect to the attribute;
calculating a downside for the product by taking the difference between the base preference and the overall preference, where the overall preference is the ratio of the number of test subjects who preferred the product overall to the total number of test subjects; and
calculating an upside for the product by taking the difference between the overall preference and the best preference, where the best preference is the ratio of the number of test subjects who preferred the product both overall and with respect to the attribute to the number of test subjects who preferred the product with respect to the attribute.

20. A test results interpretation system comprising:
a computer;
a computer code resident on the computer, wherein the code is adapted to calculate product preference upside and downside based on preference results; and
means for incorporating nonpreferential results into the product preference calculation.

21. A test results interpretation system comprising:
a matrix of responses including preference results by input choices;
a computer code resident on a computer adapted to calculate product preference for a product by incorporating preference results and nonpreferential results.

22. The system of claim 21, wherein the computer code is adapted to calculate a base preference for the product.

23. The system of claim 22, wherein the base preference is the overall preference for the product where no test subject prefers the product on its delivery of an attribute.

24. The system of claim 22, wherein the base preference is the ratio of the number of test subjects who preferred the product overall but not with respect to the attribute to the number of test subjects who did not prefer the product with respect to the attribute.

25. The system of claim 21, wherein the computer code is adapted to calculate a downside for the product.

26. The system of claim 25, wherein the downside is the incremental overall preference above the base preference attributable to the attribute.

27. The method of claim 25, wherein calculating the downside for the product includes taking the difference between a base preference and an overall preference, wherein the overall preference is the ratio of the number of test subjects who preferred the product overall to the total number of test subjects.

28. The system of claim 21, wherein the computer code is adapted to calculate an upside for the product.

29. The system of claim 28, wherein the upside is the incremental overall preference attributable to the maximum potential attribute preference.

30. The system of claim 28, wherein calculating an upside for the product includes taking the difference between the overall preference and the best preference, where the best preference is the ratio of the number of test subjects who preferred the product both overall and with respect to the attribute to the number of test subjects who preferred the product with respect to the attribute.
